(19) United States
(12) Patent Application Publication
(10) Pub. No.: US 2017/0088289 A1
(43) Pub. Date: Mar. 30, 2017

(54) METHOD FOR DETECTING LEAKS IN AIRCRAFT WINGS

(71) Applicant: Airbus Operations Limited, Bristol (GB)

(72) Inventor: Giovanni TOVAZZI, Bristol (GB)

(21) Appl. No.: 15/276,030

(22) Filed: Sep. 26, 2016

(30) Foreign Application Priority Data
Sep. 25, 2015 (GB) 1516950.1

(51) Int. Cl. B64F 5/00; G01M 3/20; B64C 3/18

(52) U.S. Cl. CPC B64F 5/0045; B64C 3/187; G01M 3/20

(57) ABSTRACT

A method and kit for detecting leaks in an aircraft wing (5) including: providing an aircraft wing structure having at an outboard end a wing tip (11) and at an inboard end a wing root (9) and at least one rib disposed between the wing root (9) and the wing tip (11), there being in a first rib section (13) of the wing (5) a first rib (19) closest to the wing root (9); placing a gas-impermeable bladder (43) over the wing root (9); forming a gas-tight circumferential seal between the bladder (43) and an outer surface of the wing (5) in the first rib section (13); introducing a gas into the aircraft wing (5); and sensing for leaks in the aircraft wing (5).

The present invention relates to a method for detecting leaks in an aircraft wing and a kit for sealing at least part of a wing to enable leak testing to take place.

It is important for wings of an aircraft to be substantially leak-free. This is especially important for aircraft with fuel tanks in the wings, such as so-called “wet wing” aircraft in which fuel is stored within the wings without use of a bladder or other fuel-containing structure.

The conventional, known method of determining whether a wing is leak-free is now described. The wing is tested prior to attachment of the wing to the rest of the aircraft so that if any leaks are detected, they can be fixed prior to attachment of the wing. A gas (typically helium or a helium-containing gas mixture) is introduced into the wing and any leakages detected. In order for leak testing to take place, the inboard part of the wing is sealed at the rib in the wing (sometimes called Rib 2 because when the wing is attached to the aircraft, this rib is the second closest rib to the fuselage). Any apertures in this rib (for example, apertures which are provided in ribs for the passage therethrough of fuel pipes, wiring and the like) are sealed. Such apertures are sealed using small bungs and seals, and modelling clay is typically used to try to block some of the leak paths. Larger apertures (such as so-called “mouseholes”) are sealed using rigid templates, tapes and modelling clay, with sealant being used if necessary. The process of sealing all leak paths in the rib can be complicated, time-consuming, messy and expensive. The sealed rib, being exposed to a substantial lateral pressure during testing, often requires strengthening supports (so-called “ironworks”) to be installed as temporary support structure before testing commences. Furthermore, removal of the modelling clay can be time-consuming and there is a risk of foreign body contamination of the wing (for example, tools being left in the wing).

EP 2 639 161 A1 describes a solution to this problem with a rigid cap fixed to a ground structure to seal the wing root. However, that fixation to the ground structure can introduce undesirable stress on the wing structure during testing. Furthermore, it is commercially desirable to have a less complex technical solution than the one described in EP 2 639 161 A1.

It is therefore an object of the present invention to provide an improved method and a kit for sealing at least part of a wing to enable leak testing to take place. The improved method should be less complicated, less time-consuming, less messy and less expensive. No undesirable structural stress should be introduced to the wing during testing.

In accordance with a first aspect of the present invention, there is provided a method for detecting leaks in an aircraft wing, the method comprising:
(i) Providing an aircraft wing structure having at an outboard end a wing tip and at an inboard end a wing root and at least one rib disposed between the wing root and the wing tip, there being in a first rib section of the wing a first rib closest to the wing root;
(ii) Placing a gas-impermeable bladder over the wing root;
(iii) Forming a gas-tight circumferential seal between the bladder and an outer surface of the wing in the first rib section;
(iv) Introducing a gas into the aircraft wing; and
(v) Sensing for leaks in the aircraft wing.

This is a very convenient way to detect leaks in aircraft wings. It is less complicated, less time-consuming, less messy and less expensive. There is also no undesirable structural stress introduced to the wing during testing. Even if there are residual holes or leakages requiring manual sealing by means of bungs, seals, or sealant, these will be heavily reduced in number and quickly accessible.

The gas-tight seal inboard of the rib closest to the wing root provides an effective way of sealing the inboard part of the wing so that leak-testing of the wing can take place. Herein, “gas-tight” or “gas-impermeable” shall mean that a defined testing pressure, e.g. 5 psi, can be kept up sufficiently long to allow the sensing for leaks in the wing taking place while minimizing the need for introducing gas to maintain the pressure. It should be noted that the aircraft wing structure is sensed for leaks and not necessarily the gas-tight circumferential seal itself. The aircraft wing structure leakage rate of Helium containing air should preferably not exceed 1·10⁻⁴ mbar·l/s, whereas the leakage rate of the gas-tight circumferential seal may be higher.

For the avoidance of doubt, it should be noted that the wing is unattached to the rest of the aircraft, i.e. testing is performed on the wing prior to the wing being attached to the rest of the aircraft.

For the avoidance of doubt, it should be noted that the method steps do not have to take place in that order. For example, the step of introducing a gas into the aircraft wing may cause the formation of a gas-tight seal.

The method of the present invention may be used to test for the presence of leaks in substantially a whole wing or in a wing compartment, for example a wing compartment defined by upper and lower wing skins and two adjacent spars. Such a compartment may typically extend from the wing tip to the wing root.

Preferably, the circumferential seal may be formed within a range of 25 cm inboard of the first rib. The first rib section of the wing preferably extends within a range of 25 cm distance to the first rib (often referred to as rib2), which is closest to the wing root before the wing is attached to the fuselage of the aircraft. The first rib section is in particular stabilised against radially inward pressure by the first rib.

Optionally, the step of forming a gas-tight circumferential seal may comprise applying radially inward pressure to close any leakage between the bladder and the outer surface of the wing in the first rib section. Herein, “spanwise” shall mean along a longitudinal wing axis that extends centrally through the wing in wing span direction from the wing root to the wing tip, whereas “radially inward” shall mean a vector pointing towards that spanwise wing axis. On the one hand, the radial inward pressure can close any leakage between the bladder and the outer surface of the wing. On the other hand, the radially inward pressure fixes the bladder mechanically to the wing to avoid any displacement of the bladder during testing.

Preferably, the radially inward pressure may be applied by using a band clamp, a web clamp, a Marman clamp, a ratchet strap, a jubilee clip, or another suitable clamping device for applying radially inward pressure for sealing and mechanically fixing through circumferential tightening. By this, the radially inward pressure may be circumferentially distributed in an uncomplicated way to avoid undesired structural stress.

Optionally, the method may further comprise the step of providing at least one profile adaptor to be located between the bladder and the outer surface of the wing in the first rib section, the at least one profile adaptor having a first surface portion to match the outer surface of the wing in the first rib section and a second surface portion to match the shape of the bladder. Such a profile adaptor may be in particular useful to seal the wing surface where it is not smoothly curved, but where it contains edges, corners, indents, or protrusions.

Preferably, the step of forming a gas-tight circumferential seal may comprise applying radially inward pressure to urge the bladder into sealing contact with the at least one profile adaptor and to urge the at least one profile adaptor into sealing contact with the outer surface of the wing in the first rib section. In this way, the at least one profile adaptor can act as a seal between the bladder and the wing surface.

More preferably, the first surface portion of the at least one profile adaptor and the second surface of the at least one profile adaptor may have a distance to each other to allow for a radial convenience gap between the bladder and the outer surface of the wing root. Such a convenience gap makes the step of placing the gas-impermeable bladder over the wing root more convenient and time-efficient.

Optionally, at least one suspension lug may protrude from the inner surface of an inboard portion of the bladder and the step of placing a gas-impermeable bladder over the wing root comprises fixing the at least one suspension lug to an inboard portion of the wing root. Given the considerable size of the bladder and the gas pressure to withstand during testing, there may be substantial forces needed to keep the bladder in place during testing. The advantage of the at least one suspension lug is that it can absorb a large portion of that force to relieve the force on the circumferential seal. This is in particular useful in regard of the force vector in spanwise inboard direction perpendicular to a radially inward pressure applied for sealing. One or more suspension lugs to fix the inner bladder to the wing could simply reduce the danger of the bladder slipping off under gas pressure during testing. The structural stress on the wing induced by the lugs can be tolerated as the main force vector pulls in spanwise inboard direction along the wing skin.

In accordance with a second aspect of the present invention, there is provided a kit for forming a seal at a first rib section of an aircraft wing for detecting leaks in the aircraft wing, the kit comprising:
(i) a substantially gas-impermeable bladder configured to be placed over a wing root of the wing and
(ii) a clamping device for applying radially inward pressure for sealing and mechanically fixing through circumferential tightening,
   wherein the clamping device is configured to form a gas-tight circumferential seal between the bladder and an outer surface of the wing at the first rib section by radially inward pressure on the bladder.

Preferably, the clamping device is a band clamp, a web clamp, a Marman clamp, a ratchet strap, or a jubilee clip. By this, the radially inward pressure may be circumferentially distributed in an uncomplicated way to avoid undesired structural stress.

Optionally, the kit may comprise at least one profile adaptor to be located between the bladder and the wing at the first rib section, the at least one profile adaptor having a first surface portion to match the outer surface of the wing in the first rib section and a second surface portion to match the shape of the bladder. Such a profile adaptor may be in particular useful to seal the wing surface where it is not smoothly curved, but where it contains edges, corners, indents, or protrusions. The at least one profile adaptors may be a separate part or an integral part of the bladder.

Preferably, the first surface portion of the at least one profile adaptor and the second surface of the at least one profile adaptor have a distance to each other to allow for a radial convenience gap between the bladder and the outer surface of the wing root. Such a convenience gap makes the step of placing the gas-impermeable bladder over the wing root more convenient and time-efficient.

Optionally, at least one suspension lug may protrude from the inner surface of an inboard portion of the bladder, the at least one suspension lug is configured to be fixed to an inboard portion of the wing root. Given the considerable size of the bladder and the gas pressure to withstand during testing, there may be substantial forces needed to keep the bladder in place during testing. The advantage of the at least one suspension lug is that it can absorb a large portion of that force to relieve the force on the circumferential seal. This is in particular useful in regard of the force vector in spanwise inboard direction perpendicular to a radially inward pressure applied for sealing. One or more suspension lugs to fix the inner bladder to the wing could simply reduce the danger of the bladder slipping off under gas pressure during testing. The structural stress on the wing induced by the lugs can be tolerated as the main force vector pulls in spanwise inboard direction along the wing skin.

Preferably, the bladder is at least partially flexible to be manually mantled over the wing root. On the one hand, the bladder is preferably as flexible as possible to facilitate a manual mantling and dismantling process. On the other hand, the bladder with a volume of more than a cubic metre must be able to safely hold gas pressures up to 5 psi without bursting or significant expanding. For instance, the bladder may comprise Butyl Rubber, Polyvinyl Chloride, EPDM Rubber, Polypropylene, Elvaloy®, Polyethylene, Polyurethane, or another suitably flexible and resistant material.

In order to induce as little as possible structural stress on the wing, the bladder should be as lightweight as possible. Therefore, the bladder may comprise lightweight structural support features like a web, a mesh, fibres, or a skeleton-like framework.

Preferably, the kit is configured to form a gas-tight circumferential seal to hold a gas pressure of 5 psi or more, for more safety 10 psi or more, to allow sensing for leaks in the wing with a leakage rate below 1·10⁻⁴ mbar·l/s.

Both, the method of the first aspect of the present invention and the kit of the second aspect of the present invention are of greater application to larger aircraft. In this connection, the aircraft is preferably heavier than 40 tonnes zero fuel weight, and more preferably heavier than 50 tonnes zero fuel weight. The aircraft is preferably of a size equivalent to an aircraft designed to carry more than 75 passengers, and more preferably more than 100 passengers. The aircraft may optionally have a wingspan of at least 25 m and optionally of at least 30 m. The length of the leading edge of the wing may optionally be at least 10 m and optionally at least 15 m. The wing root form the first rib inwards may comprise a volume of more than a cubic metre.

The present invention will now be described by way of example only with reference to the following figures of which:

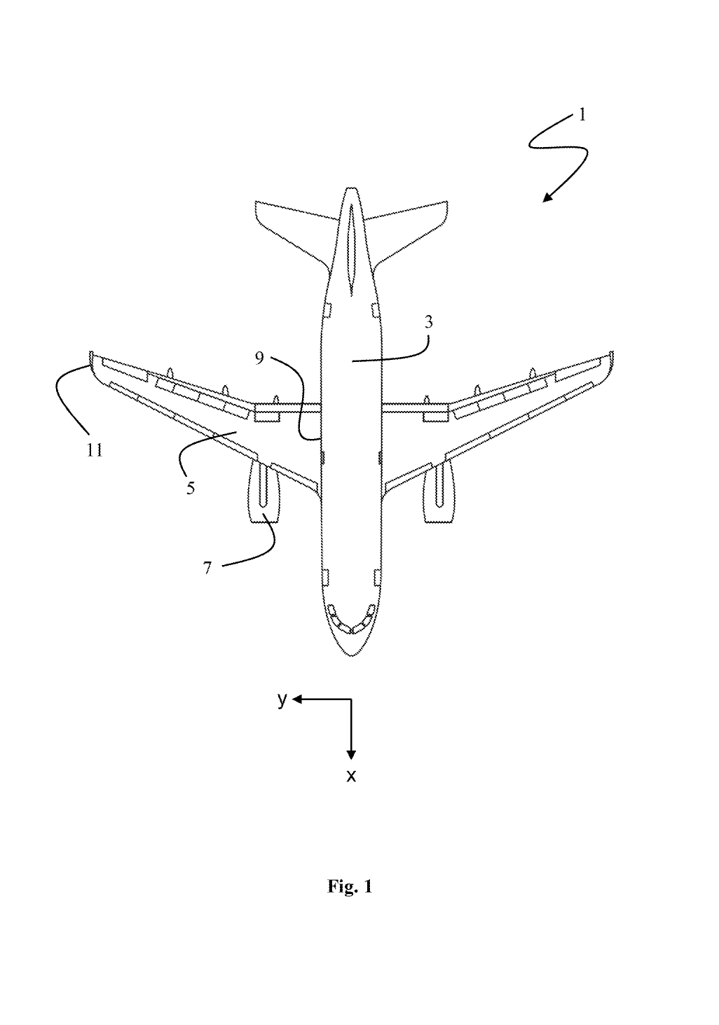

FIG. 1 is a schematic top view on a fully assembled aircraft having fixed wings attached to it after an embodiment of the inventive concept for detecting leaks in the wings has been carried out;

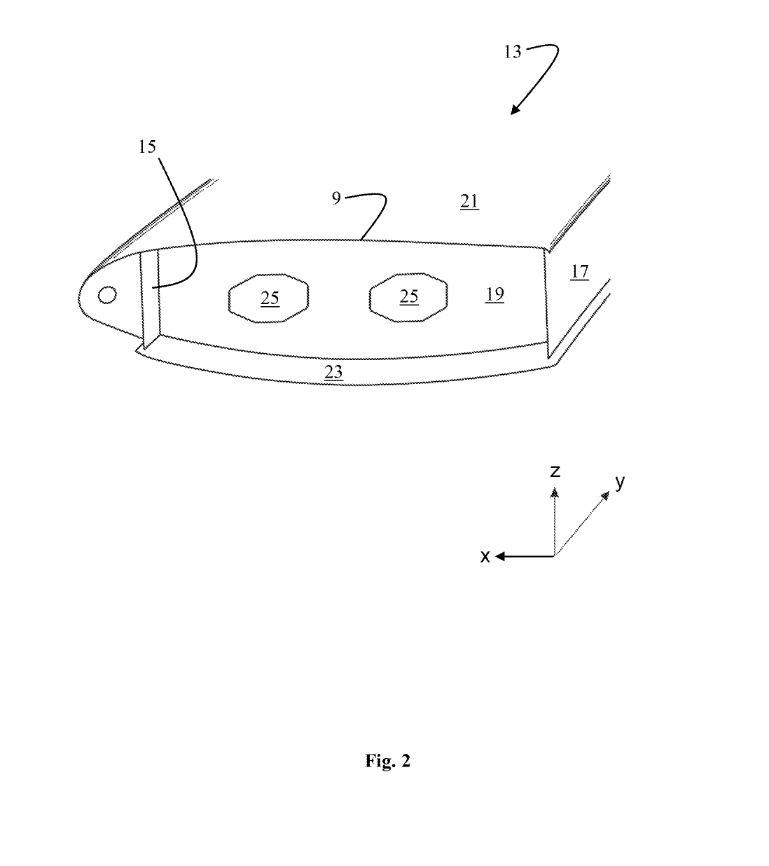

FIG. 2 is a schematic perspective view on a wing root section of an aircraft wing before the wing is attached to the aircraft and before an embodiment of the inventive concept for detecting leaks in the wing has been carried out;

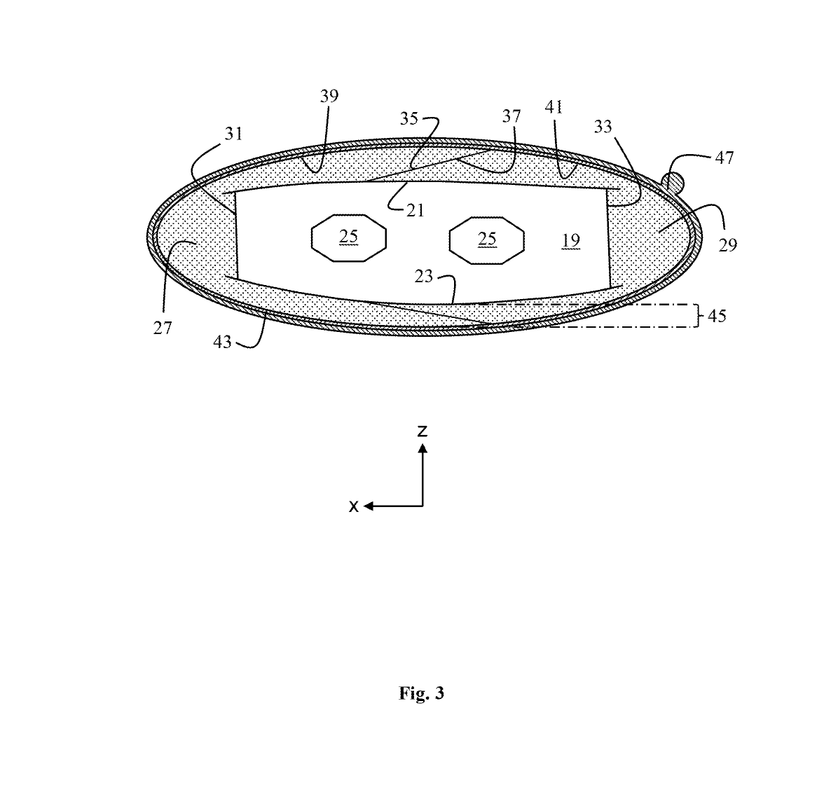

FIG. 3 is a schematic chordwise cross-sectional view through a wing root of an aircraft wing at the rib closest to the wing root before the wing is attached to the aircraft and while an embodiment of the inventive concept for detecting leaks in the wing is being carried out;

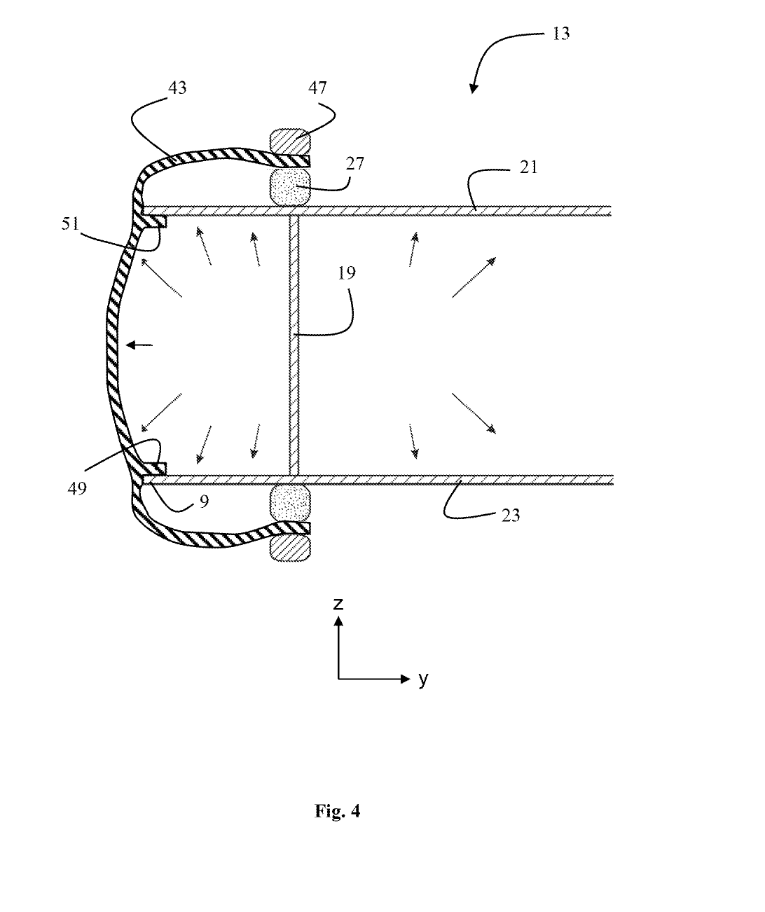

FIG. 4 is a schematic spanwise cross-sectional view through a wing root of an aircraft wing before the wing is attached to the aircraft and while an embodiment of the inventive concept for detecting leaks in the wing is being carried out;

FIG. 1 shows a fully assembled commercial passenger aircraft 1 with a fuselage 3 and fixed wings 5 attached to it. Inner volumes of the wings 5 serve as fuel tanks to store fuel for combustion in engines 7 when the aircraft 1 is operated. To test the wings' 5 tightness for storing fuel without leakage, the wings 5 may be checked for potential leaks before they are attached to the fuselage 3. A detection of leaks before the wings 5 are attached to the fuselage 3 has the advantage that detected leaks can be closed more easily. After the wings 5 are attached to the fuselage 3, detected leaks are less accessible and more complicated to close. In addition to leakage detection before the wings 5 are attached to the fuselage 3, it may be useful to test the wings' 5 tightness again after the wings 5 are attached to the fuselage 3.

The right-handed Cartesian coordinate system in each figure is intended to facilitate orientation. The longitudinal x-direction (rolling axis of the aircraft 1) runs along the fuselage 3 and in chordwise direction of the wings 5. The y-direction (pitch axis of the aircraft 1) is perpendicular to the x-axis in spanwise direction of the wings 5. “Inboard” means spanwise towards the fuselage 3 or, when the wing 5 is not yet attached to the fuselage 3, towards a wing root 9 configured to be attached to the fuselage 3. “Outboard” means spanwise away from the fuselage 3 or, when the wing 5 is not yet attached to the fuselage 3, towards the wing tip 11. The z-axis (yaw axis of the aircraft 1) runs vertical.

FIG. 2 shows a first rib section 13 of the wing 5 before the wing 5 is attached to the fuselage 3. The wing 5 comprises an inner volume configured to store fuel for combustion in aircraft engines. The inner volume is confined between a wing front spar 15 extending spanwise along the wing 5 in a forward section of the wing 5 and a wing rear spar 17 extending spanwise along the wing 5 in an aft section of the wing 5. Ribs extend essentially chordwise between the front spar 15 and the rear spar 17. Only a first rib 19 (sometimes called “Rib 2” because when the wing is attached to the fuselage, this rib is the second closest rib to the fuselage) is visible in FIG. 2. An upper wing skin 21 defines the inner volume of the wing 5 from the top and a lower wing skin 23 defines the inner volume of the wing 5 from the bottom.

The first rib 19 contains a large number of apertures 25 of which only the largest two are shown in FIG. 2. The apertures 25 have various positions, sizes, shapes and functions. Other ribs have similar apertures and fluid can flow between wing boxes that are defined between the ribs. Before the wing 5 is attached to the fuselage 3, the apertures 25 of the first rib 19 are the remaining openings of the inner volume of the wing 5.

FIG. 3 shows how the apertures 25 of the first rib 19 may preferably be sealed for detecting leakages of the wing 5. Two profile adaptors 27, 29 are placed around the first rib section 13 to embrace the wing 5 circumferentially. The profile adaptors 27, 29 each have a first surface portion 31, 33 to specifically match the outer contour of the wing 5. The first surface portions 31, 33 preferably comprise sealing material configured to circumferentially seal the outer wing contour upon application of a radially inward force. The profile adaptors 27, 29 may also comprise contact surfaces 35, 37 comprising a sealing material configured to provide a sealing contact of the profile adaptors 27, 29 to each other upon application of a radially inward force. Preferably, these contact surfaces 35 may be tapered and matching each other.

The profile adaptors 27, 29 each further have a second surface portion 39, 41 to provide an oval cross-sectional shape. This oval cross-sectional shape matches with the oval cross-sectional shape of a bladder 43 that is pulled over the wing root 9 to seal the wing root 9 for detecting leakages of the wing 5. The first surface portion 31, 33 and the second surface portion 39, 41 have a distance to each other to allow for a radial convenience gap 45 between the bladder 43 and the outer surface of the wing root 9. The convenience gap 45 allows the bladder 43 to have a larger diameter which is more convenient for pulling it over the wing root 9.

The second surface portions 39, 41 preferably comprise sealing material configured to circumferentially seal an inner surface of the bladder 43 upon application of a radially inward force. Such a gas-tight circumferential seal is provided by applying radially inward pressure to close any leakage between the bladder 43 and the outer surface of the wing 5 in the first rib section 13.

The radially inward pressure is applied by a clamping device 47 circumferentially placed around the bladder 43 and tightened to urge the bladder 43 into fixing and sealing contact with the profile adaptors 27, 29 and the profile adaptors 27, 29 into fixing and sealing contact with the wing 5. The clamping device 47 may be a band clamp, a web clamp, a Marman clamp, a ratchet strap, a jubilee clip, or another suitable clamping device for applying radially inward pressure for sealing and mechanically fixing through circumferential tightening.

FIG. 4 shows the first rib section 13 during detecting leaks in the wing 5. The wing 5 is pressurised by Helium mixed with air to a gas pressure of about 5 psi. The gas pressure can result in a substantial force of several tonnes on the bladder 43. That force is mainly directed spanwise inboard to pull the bladder 43 out of the sealing contact with the wing 5 and to blow the bladder 43 off the wing root 9. In order to substantially reduce that spanwise inboard force on the sealing contact, the bladder 43 preferably comprises at least one suspension lug 49 protruding from the inner surface of the bladder 43 an inboard portion of the bladder 43. Before the bladder 43 is fully pulled over the wing root 9, the at least one suspension lug 49, 51 can be fixed to an inboard portion of the wing root 9. Most preferably, several suspension lugs 49, 51 are provided in a distributed manner at the inner surface of the bladder 43 to distribute the spanwise inboard force. The positions for fixing the suspension lugs 49, 51 may actually be same as the ones that were used in the prior art for installing the ironworks.

There are many different ways in which leaks could be detected while the inner volume of the wing 5 is pressurised. For example, leaks may be monitored manually using one or more operators. Alternatively or additionally, one or more static sensors may be used. Alternatively or additionally, one of more automated movable sensors could be used.

Where, in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as optional, preferable, advantageous, convenient or the like are optional and do not limit the scope of the independent claims.

While at least one exemplary embodiment of the present invention has been shown and described, it should be understood that other modifications, substitutions and alternatives are apparent to one of ordinary skill in the art and may be changed without departing from the scope of the subject matter described herein, and this application is intended to cover any adaptations or variations of the specific embodiments discussed herein. In addition, “comprising” does not exclude other elements or steps, and “a” or “one” does not exclude a plural number. Furthermore, characteristics or steps which have been described with reference to one of the above exemplary embodiments may also be used in combination with other characteristics or steps of other exemplary embodiments described above. It should be understood that there should be embodied within the scope of the patent warranted hereon all such modifications as reasonably and properly come within the scope of the contribution to the art. Such modifications, substitutions and alternatives can be made without departing from the spirit and scope of the invention, which should be determined from the appended claims and their legal equivalents.

1. A method for detecting leaks in an aircraft wing, the method comprising:
providing an aircraft wing structure having at an outboard end a wing tip and at an inboard end a wing root and at least one rib disposed between the wing root and the wing tip, there being in a first rib section of the wing a first rib closest to the wing root;
placing a gas-impermeable bladder over the wing root;
forming a gas-tight circumferential seal between the bladder and an outer surface of the wing in the first rib section;
introducing a gas into the aircraft wing; and
sensing for leaks in the aircraft wing.

2. The method according to claim 1, wherein the circumferential seal is formed within a range of 25 cm inboard of the first rib.

3. The method according to claim 1, wherein the step of forming a gas-tight circumferential seal comprises applying radially inward pressure to close any leakage between the bladder and the outer surface of the wing in the first rib section.

4. The method according to claim 3, wherein the radially inward pressure is applied by using at least one of a band clamp, a web clamp, a Marman clamp, a ratchet strap, a jubilee clip, or another suitable clamping device for applying radially inward pressure for sealing and mechanically fixing through circumferential tightening.

5. The method according to claim 1 further comprising the step of providing at least one profile adaptor to be located between the bladder and the outer surface of the wing in the first rib section, the at least one profile adaptor having a first surface portion to match the outer surface of the wing in the first rib section and a second surface portion to match a shape of the bladder.

6. The method according to claim 5, wherein the step of forming a gas-tight circumferential seal comprises applying radially inward pressure to urge the bladder into sealing contact with the at least one profile adaptor and to urge the at least one profile adaptor into sealing contact with the outer surface of the wing in the first rib section.

7. The method according to claim 6, wherein the first surface portion of the at least one profile adaptor and the second surface portion of the at least one profile adaptor have a distance to each other to allow for a radial convenience gap between the bladder and the outer surface of the wing root.

8. The method according to claim 1 wherein at least one suspension lug protrudes from the inner surface of an inboard portion of the bladder and wherein the step of placing a gas-impermeable bladder over the wing root comprises fixing the at least one suspension lug to an inboard portion of the wing root.

9. A kit for forming a seal at a first rib section of an aircraft wing for detecting leaks in the aircraft wing, the kit comprising
a substantially gas-impermeable bladder configured to be placed over a wing root of the wing, and
a clamping device configured to apply radially inward pressure for sealing and mechanically fixing through circumferential tightening,
wherein the clamping device is configured to form a gas-tight circumferential seal between the bladder and an outer surface of the wing at the first rib section by radially inward pressure on the bladder.

10. The kit according to claim 9, wherein the clamping device is at least one of a band clamp, a web clamp, a Marman clamp, a ratchet strap, and a jubilee clip.

11. The kit according to claim 9, further comprising at least one profile adaptor to be located between the bladder and the wing, the at least one profile adaptor having a first surface portion to match the outer surface of the wing at the first rib section and a second surface portion to match the shape of the bladder.

12. The kit according to claim 11, wherein the first surface portion of the at least one profile adaptor and the second surface of the at least one profile adaptor have a distance to each other to allow for a radial convenience gap between the bladder and the outer surface of the wing root.

13. The kit according to claim 9, wherein at least one suspension lug protrudes from the inner surface of an inboard portion of the bladder, the at least one suspension lug is configured to be fixed to an inboard portion of the wing root.

14. The kit according to claim 9, wherein the bladder is at least partially flexible to be manually mantled over the wing root.

15. The kit according to claim 9, wherein the kit is configured to form a gas-tight circumferential seal to hold a gas pressure of 5 psi or more to allow sensing for leaks in the wing with a leakage rate of Helium containing air below 1·10⁻⁴ mbar·l/s.

16. A method to detect a leak in an aircraft wing including a wing tip, a wing root, a rib between the wing tip and wing root, the method comprising:
providing an aircraft wing structure including a wing tip at an outboard end of the wing structure, a wing root at an inboard end of the wing structure; ribs between the wing root and the wing tip, and a first rib section between the wing root and a first rib of the ribs, wherein the first rib is the rib nearest the wing root;
placing a gas-impermeable bladder over and covering the wing root;
sealing an open end of the bladder to an outer wing surface of the first rib section to form a gas-tight seal between the bladder and the outer wing surface of the first rib surface;
introducing a gas into the aircraft wing structure while the open end of the bladder is sealed to the outer wing surface of the first rib section; and
sensing for gas leaks emanating from the aircraft wing while introducing the gas into the aircraft wing structure and while the open end of the bladder is sealed to the outer wing surface of the first rib section.

17. The method of claim 16 wherein the gas-tight seal extends around a circumference of the outer wing surface of the first rib section.

18. The method of claim 16 wherein the gas-tight seal is within 10 inches of the first rib along a span-wise direction of the wing structure.

19. The method according to claim 16 further comprising:
providing at least one profile adaptor between the gas-impermeable bladder and the outer wing surface of the first rib section, wherein the at least one profile adaptor includes a first surface portion configured to match the outer wing surface and a second surface portion configured to match a surface of the open end of the bladder.

20. The method according to claim 16, wherein the first surface portion of the at least one profile adaptor and the second surface portion of the at least one profile adaptor are separated by a distance selected to allow for a radial convenience gap between the bladder and an outer surface of the wing root.
